(19) United States
(12) Patent Application Publication
(10) Pub. No.: US 2021/0056140 A1
(43) Pub. Date: Feb. 25, 2021

(54) User Profile Generation Method and Apparatus

(71) Applicant: Huawei Technologies Co., Ltd., Shenzhen (CN)

(72) Inventors: Shubo Zhang, Beijing (CN); Hsin-Ti Chueh, Shenzhen (CN); Hui Yi, Shenzhen (CN); Yuchao Lin, Shenzhen (CN); Sunghao Lin, Shenzhen (CN)

(21) Appl. No.: 16/963,572

(22) PCT Filed: Jan. 22, 2018
(86) PCT No.: PCT/CN2018/073671

§ 371 Date: Jul. 21, 2020

(51) Int. Cl. G06F 16/9035; G06F 16/901; G06N 20/00

(52) U.S. Cl. CPC G06F 16/9035; G06N 20/00; G06F 16/901

(57) ABSTRACT

A user profile generation method and an apparatus. The method includes: sending, by a terminal, at least one short-term user profile generated for a user to a server, where the at least one short-term user profile reflects a behavioral characteristic of the user in first duration; receiving, by the terminal, a long-term user profile generated by the server for the user, where the long-term user profile is generated by the server at least based on the at least one short-term user profile, the long-term user profile reflects a behavioral characteristic of the user in second duration, and the first duration is longer than the second duration; and providing, by the terminal, at least a part of the long-term user profile for a first application.

### TECHNICAL FIELD

Embodiments of this application relate to a smart technology, and in particular, to a user profile generation method and an apparatus.

### BACKGROUND

With continuous development of an information and communications technology (information communication technology, ICT), human activities in a physical world are increasingly integrated into a digital world.

In the digital world, a terminal such as a mobile phone may abstract an actual user into a user profile with one or more tags based on a use behavior of the user. For example, if a user A often uses a mobile phone to watch an animation after 12:00 p.m., the mobile phone may use tags such as “Night owl” and “ACG fanatic” as a user profile of the user A. Then, the mobile phone may provide a customized service and function for the user based on the user profile of the user A, to improve working efficiency of the mobile phone.

Usually, a mobile phone may collect behavioral data generated when a user uses the mobile phone such as global positioning system (global positioning system, GPS) information, call information, and operation information on an APP. Further, the mobile phone may generate a user profile of the user based on the behavioral data through machine learning or the like, or the mobile phone may upload the behavioral data to a server, so that the server creates the user profile for the user and then delivers the user profile to the mobile phone.

However, due to a limitation on a calculation capability and a storage capability of the mobile phone, a capability of performing machine learning when the mobile phone generates the user profile is relatively weak, and long-term behavioral data of the user cannot be stored. As a result, the generated user profile is not accurate enough. When the server generates the user profile, the mobile phone needs to consume a large amount of traffic to upload the foregoing behavioral data, and sensitive data such as user privacy included in the behavioral data is prone to leakage.

### SUMMARY

Embodiments of this application provide a user profile generation method and an apparatus, so that traffic consumption and a risk of privacy leakage can be reduced while accuracy of a user profile is improved.

To achieve the foregoing objective, the following technical solutions are used in the embodiments of this application.

According to a first aspect, an embodiment of this application provides a user profile generation method, including: sending, by a terminal, at least one short-term user profile generated for a user (the at least one short-term user profile reflects a behavioral characteristic of the user in first duration) to a profile server; receiving, by the terminal, a long-term user profile generated by the profile server for the user (the long-term user profile reflects a behavioral characteristic of the user in second duration, and the second duration is longer than the first duration), where the long-term user profile is generated by the profile server at least based on the at least one short-term user profile; and then providing, by the terminal, at least a part of the long-term user profile for a first application.

It may be learned that, in a process of generating a user profile, the terminal sends a short-term user profile with a relatively small data amount and a relatively low privacy to the profile server, so that the profile server generates a long-term user profile with relatively high accuracy and stability for the user based on the short-term user profile. In this way, traffic consumption and a risk of privacy leakage can be reduced while accuracy of a user profile is improved.

In a possible design method, before the sending, by a terminal, at least one short-term user profile generated for a user to a profile server, the method further includes: collecting, by the terminal, behavioral data generated when the user uses the terminal; and generating, by the terminal, the at least one short-term user profile of the user based on behavioral data collected in latest first duration, where the short-term user profile includes at least one user tag and a characteristic value of each of the at least one user tag.

For example, the behavioral data may include data that is generated when an application at an application layer runs and that reflects a user behavioral characteristic, data that is generated when a service at a framework layer runs and that reflects a user behavioral characteristic, and data that is generated when a sensor of the terminal runs and that reflects a user behavioral characteristic. In this case, the collecting, by the terminal, behavioral data generated when the user uses the terminal may specifically include: collecting, by the terminal, the behavioral data in at least one manner of listening to a broadcast message, reading a specific data interface, calling a system service, and performing tracing point collection.

In a possible design method, the generating, by the terminal, the at least one short-term user profile of the user based on behavioral data collected in the first duration specifically includes: performing, by the terminal, statistical analysis and machine learning on the behavioral data collected in the first duration, to obtain the at least one user tag of the user in the first duration and the characteristic value of each of the at least one user tag.

In a possible design method, the method further includes: storing, by the terminal, the short-term user profile and the long-term user profile into a database of the terminal, where the database stores a short-term user profile in at least one latest first duration.

When the short-term user profile is being generated, the terminal needs to process only the behavioral data in the first duration with a relatively short time span. Therefore, implementation complexity of the terminal is greatly reduced, and a lot of calculation resources and storage resources of the terminal are not consumed when the short-term user profile is being generated.

According to a second aspect, an embodiment of this application provides a user profile generation method, including: obtaining, by a profile server, at least one short-term user profile sent by a terminal, where the at least one short-term user profile reflects a behavioral characteristic of the user in first duration; generating, by the profile server, a long-term user profile for the user based on the at least one short-term user profile, where the long-term user profile reflects a behavioral characteristic of the user in second duration, and the second duration is longer than the first duration; and sending, by the profile server, the long-term user profile to the terminal.

In a possible design method, the short-term user profile includes at least one user tag and a characteristic value of each of the at least one user tag; and the long-term user profile includes at least one user tag and a characteristic value of each of the at least one user tag.

In a possible design method, after the generating, by the profile server, a long-term user profile for the user based on the at least one short-term user profile, the method further includes: receiving, by the profile server, a first query request sent by a third-party application profile server, where the first query request is used to request to query the long-term user profile of the user; and sending, by the profile server, the long-term user profile of the user to the third-party application profile server in response to the first query request.

In a possible design method, the profile server stores a correspondence between each of a plurality of users and the long-term user profile of the user, and the method further includes: receiving, by the profile server, a second query request sent by a third-party application profile server, where the second query request includes a user type requested by the third-party application profile server; in response to the second query request, searching, by the profile server, long-term user profiles of the plurality of users for a target long-term user profile that meets the user type; and sending, by the profile server, an identifier of at least one user corresponding to the target long-term user profile to the third-party application profile server.

In a possible design method, the method further includes: storing, by the profile server, a received short-term user profile into a first database of the profile server; and storing, by the profile server, a received long-term user profile into a second database of the profile server.

According to a third aspect, an embodiment of this application provides a user profile generation method, including: obtaining, by a profile server, a first short-term user profile sent by a first terminal and a second short-term user profile sent by a second terminal, where the first short-term user profile reflects a behavioral characteristic of a first user in first duration, and the second short-term user profile reflects a behavioral characteristic of a second user in the first duration; generating, by the profile server, a first long-term user profile for the first user based on the first short-term user profile, where the first long-term user profile reflects a behavioral characteristic of the first user in second duration (the second duration is longer than the first duration); generating, by the profile server, a second long-term user profile for the second user based on the second short-term user profile, where the second long-term user profile reflects a behavioral characteristic of the second user in the second duration; and sending, by the profile server, the first long-term user profile to the first terminal, and sending the second long-term user profile to the second terminal.

According to a fourth aspect, an embodiment of this application provides a terminal, including a profile management module, and a data collection module, a profile calculation module, a profile query module, and a database that are all connected to the profile management module. The profile management module is configured to send at least one short-term user profile generated for a user to a profile server, where the at least one short-term user profile reflects a behavioral characteristic of the user in first duration. The profile management module is further configured to receive a long-term user profile generated by the profile server for the user, where the long-term user profile is generated by the profile server at least based on the at least one short-term user profile, the long-term user profile reflects a behavioral characteristic of the user in second duration, and the second duration is longer than the first duration. The profile query module is configured to provide at least a part of the long-term user profile for a first application.

In a possible design method, the data collection module is configured to collect behavioral data generated when the user uses the terminal. The profile calculation module is configured to generate the at least one short-term user profile of the user based on behavioral data collected in latest first duration, where the short-term user profile includes at least one user tag and a characteristic value of each of the at least one user tag.

In a possible design method, the behavioral data includes data that is generated when an application at an application layer runs and that reflects a user behavioral characteristic, data that is generated when a service at a framework layer runs and that reflects a user behavioral characteristic, and data that is generated when a sensor of the terminal runs and that reflects a user behavioral characteristic. The data collection module is specifically configured to collect the behavioral data in at least one manner of listening to a broadcast message, reading a specific data interface, calling a system service, and performing tracing point collection.

In a possible design method, the profile calculation module is specifically configured to perform statistical analysis and machine learning on the behavioral data collected in the first duration, to obtain the at least one user tag of the user in the first duration and the characteristic value of each of the at least one user tag.

In a possible design method, the profile management module is further configured to store the short-term user profile and the long-term user profile into the database, where the database stores a short-term user profile in at least one latest first duration.

According to a fifth aspect, an embodiment of this application provides a profile server, including a profile management module, and a profile calculation module and a profile query module that are both connected to the profile management module. The profile management module is configured to obtain at least one short-term user profile sent by a terminal, where the at least one short-term user profile reflects a behavioral characteristic of the user in first duration. The profile calculation module is configured to generate a long-term user profile for the user based on the at least one short-term user profile, where the long-term user profile reflects a behavioral characteristic of the user in second duration, and the second duration is longer than the first duration. The profile management module is further configured to send the long-term user profile to the terminal.

In a possible design method, the profile query module is configured to: receive a first query request sent by a third-party application profile server, where the first query request is used to request to query the long-term user profile of the user; and send the long-term user profile of the user to the third-party application profile server in response to the first query request.

In a possible design method, the profile server stores a correspondence between each of a plurality of users and the long-term user profile of the user; and the profile query module is configured to: receive a second query request sent by a third-party application profile server, where the second query request includes a user type requested by the third-party application profile server; in response to the second query request, search long-term user profiles of the plurality of users for a target long-term user profile that meets the user type; and send an identifier of at least one user corresponding to the target long-term user profile to the third-party application profile server.

In a possible design method, the profile management module is further configured to: store a received short-term user profile into a first database of the profile server; and store a received long-term user profile into a second database of the profile server.

According to a sixth aspect, an embodiment of this application provides a terminal, including a processor, a memory, a bus, and a communications interface. The memory is configured to store a computer executable instruction, and the processor and the memory are connected through the bus. When the terminal runs, the processor executes the computer executable instruction stored in the memory, so that the terminal performs the user profile generation method in any one of the foregoing design methods.

According to a seventh aspect, an embodiment of this application provides a profile server, including a processor, a memory, a bus, and a communications interface. The memory is configured to store a computer executable instruction, and the processor and the memory are connected through the bus. When the profile server runs, the processor executes the computer executable instruction stored in the memory, so that the profile server performs the user profile generation method in any one of the foregoing design methods.

According to an eighth aspect, an embodiment of this application provides a computer readable storage medium. The computer readable storage medium stores an instruction, and when the instruction is executed on the terminal in any one of the foregoing design methods, the terminal is enabled to perform the user profile generation method in any one of the foregoing design methods.

According to a ninth aspect, an embodiment of this application provides a computer readable storage medium. The computer readable storage medium stores an instruction, and when the instruction is executed on the profile server in any one of the foregoing design methods, the profile server is enabled to perform the user profile generation method in any one of the foregoing design methods.

According to a tenth aspect, an embodiment of this application provides a computer program product including an instruction. When the computer program product runs on the terminal in any one of the foregoing design methods, the terminal is enabled to perform the user profile generation method in any one of the foregoing design methods.

According to an eleventh aspect, an embodiment of this application provides a computer program product including an instruction. When the computer program product runs on the profile server in any one of the foregoing design methods, the profile server is enabled to perform the user profile generation method in any one of the foregoing design methods.

In the embodiments of this application, a name of each component of the terminal or the profile server imposes no limitation on the device. In actual implementation, these components may have other names, provided that functions of the components are similar to those in the embodiments of this application, that is, fall within the scope of the claims of this application and their equivalent technologies.

In addition, for technical effects brought by any one of the design manners in the second aspect to the eleventh aspect, refer to technical effects brought by different design methods in the first aspect. Details are not described herein again.

### BRIEF DESCRIPTION OF DRAWINGS

FIG. 1 is a schematic structural diagram 1 of a terminal according to an embodiment of this application;

FIG. 2 is a schematic structural diagram of a user profile platform according to an embodiment of this application;

FIG. 3 is a schematic structural diagram 1 of a profile platform end side according to an embodiment of this application;

FIG. 4 is a schematic diagram of behavioral data according to an embodiment of this application;

FIG. 5 is a schematic structural diagram 2 of a profile platform end side according to an embodiment of this application;

FIG. 6 is a schematic diagram of a user tag according to an embodiment of this application;

FIG. 7 is a schematic structural diagram 1 of a profile platform server side according to an embodiment of this application;

FIG. 8 is a schematic structural diagram 2 of a profile platform server side according to an embodiment of this application;

FIG. 9 is a schematic flowchart of a user profile generation method according to an embodiment of this application;

FIG. 10 is a schematic structural diagram 2 of a terminal according to an embodiment of this application; and

FIG. 11 is a schematic structural diagram of a profile server according to an embodiment of this application.

### DESCRIPTION OF EMBODIMENTS

With development of smart business, some intelligent reminders or services may be performed on a terminal based on a historical behavior habit of a user or according to some rules or models, so that the user can use the terminal more conveniently, and the user considers that the terminal is more intelligent.

The terminal may implement various types of smart business by using the terminal itself or by combining with a cloud. Specifically, the terminal may include a rule platform, an algorithm platform, and a profile platform end side. The terminal may use one or more of the three platforms and other resources to implement the various types of smart business, for example, 1. Service recommendation business; 2. Reminder business; and 3. Notification filtering business.

1. Service Recommendation Business

The terminal includes a recommendation service framework (framework) for implementing the service recommendation business, and the recommendation service framework may include at least an algorithm platform, a rule platform, and a profile platform end side.

The rule platform may match, according to a rule, a service that the user of the terminal expects to use in a current scenario. The algorithm platform may predict, based on a model, the service that the user of the terminal expects to use in the current scenario. The recommendation service framework may place the service predicted by the rule platform or the algorithm platform on a display interface of a recommended application, so that the user can conveniently enter an interface corresponding to the service through the display interface of the recommended application.

The rule may be delivered by a server (namely, the cloud) to the terminal. The rule may be obtained through big data statistics or through summarization based on empirical data. The model may be obtained in the following manner: user historical data and user characteristic data are trained by using the algorithm platform to obtain the model. In addition, the model may be updated based on new user data and characteristic data.

The user historical data may be behavioral data of the user using the terminal in a period of time. The user characteristic data may include a user profile (user profile) or another type of characteristic data, and the another type of characteristic data may be, for example, behavioral data of a current user. The user profile may be obtained by using the profile platform end side in the terminal.

2. Reminder Business

The terminal includes a recommendation framework (framework) for implementing the reminder business. The recommendation framework may include at least a rule platform, a graphical user interface (graphical user interface), and a profile platform end side.

The rule platform may listen to various events. An application in the terminal may register various rules with the rule platform. Then, the rule platform listens to various events in the terminal according to the registered rules, matches a detected event with a rule, and when a detected event matches all conditions of a specified rule, trigger a reminder corresponding to the rule, that is, recommend a highlight event to the user. Finally, the reminder is displayed on the graphical user interface or displayed by the application that registers the rule. Conditions of some rules may be a limitation on a user profile. The rule platform may request a current user profile from the profile platform end side, to determine whether the current user profile matches a condition of a rule.

3. Notification Filtering Business

The terminal includes a notification filtering framework (framework) for implementing the notification filtering business. The notification filtering framework may include at least a rule platform, an algorithm platform, and a profile platform end side.

When the notification filtering framework obtains a notification, a type of the notification may be determined by using the rule platform or the algorithm platform. Then, based on the type of the notification and a preference of the user, it is determined whether the notification is a notification that the user is interested in, and reminders are displayed in different manners for a notification that the user is interested in and a notification that the user is not interested in. The preference of the user may include a user profile, or may include a historical processing behavior of the user for a specified type of notification. The user profile is provided by the profile platform end side.

It should be noted that the terminal may include one rule platform, and the rule platform provides a capability required by each of the three frameworks. Alternatively, the terminal may include a plurality of rule platforms, and the plurality of rule platforms separately provide capabilities for the three frameworks. Similarly, the terminal may include one algorithm platform, and the algorithm platform provides a capability required by each of the recommendation service framework and the notification filtering framework. Alternatively, the terminal may include two algorithm platforms that separately provide capabilities for the two frameworks. The terminal may include one profile platform end side, and the profile platform end side provides a capability required by each of the three frameworks. Alternatively, the terminal may include a plurality of profile platform end sides that separately provide capabilities for the frameworks.

The following embodiments of this application mainly describe the profile platform end side in detail.

The profile platform end side provided in the embodiments of the present invention may be included in the terminal. The terminal may be, for example, a mobile phone, a tablet computer (tablet personal computer), a laptop computer (laptop computer), a digital camera, a personal digital assistant (personal digital assistant, PDA), a navigation apparatus, a mobile internet device (mobile internet device, MID), or a wearable device (wearable device).

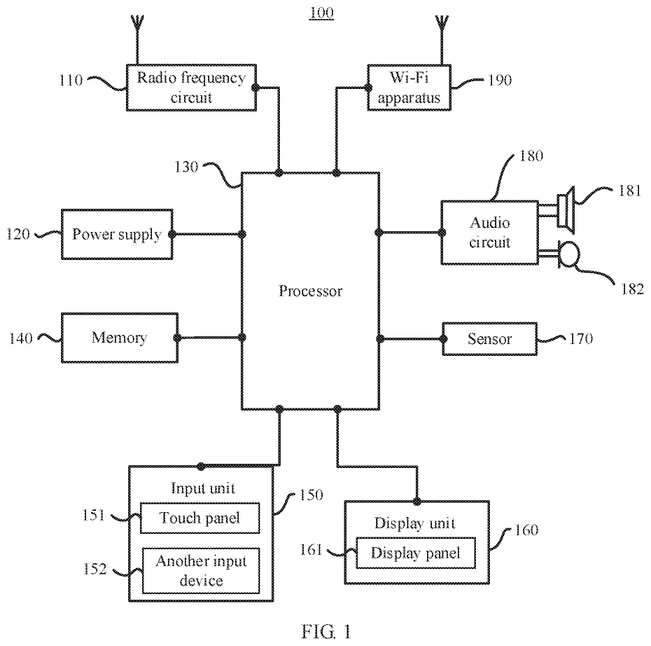

FIG. 1 is a block diagram of a partial structure of a terminal according to an embodiment of the present invention. The terminal is described by using a mobile phone 100 as an example. Referring to FIG. 1, the mobile phone 100 includes components such as a radio frequency (radio frequency, RF) circuit 110, a power supply 120, a processor 130, a memory 140, an input unit 150, a display unit 160, a sensor 170, an audio circuit 180, and a wireless fidelity (wireless-fidelity, Wi-Fi) module 190. A person skilled in the art may understand that a structure of the mobile phone shown in FIG. 1 does not constitute a limitation on the mobile phone, and the mobile phone may include more or fewer components than those shown in the figure, may combine some components, or may have different component arrangements.

Each constituent component of the mobile phone 100 is specifically described with reference to FIG. 1 below.

The RF circuit 110 may be configured to receive and send information or receive and send a signal in a call process. For example, the RF circuit 110 may send downlink data received from a base station to the processor 130 for processing, and send uplink data to the base station.

The RF circuit usually includes but is not limited to an RF chip, an antenna, at least one amplifier, a transceiver, a coupler, a low noise amplifier (low noise amplifier, LNA), a duplexer, a radio frequency switch, and the like. In addition, the RF circuit 110 may further communicate with a network and another device wirelessly. The wireless communication may use any communications standard or protocol, including but not limited to a global system for mobile communications (global system of mobile communication, GSM), a general packet radio service (general packet radio service, GPRS), code division multiple access (code division multiple access, CDMA), wideband code division multiple access (wideband code division multiple access, WCDMA), long term evolution (long term evolution, LTE), an email, a short message service (short messaging service, SMS), and the like.

The memory 140 may be configured to store a software program and a module. The processor 130 runs the software program and the module stored in the memory 140, to perform various function applications and data processing of the mobile phone 100. The memory 140 may mainly include a program storage area and a data storage area. The program storage area may store an operating system, an application program required by at least one function (such as a voice play function or an image play function), and the like. The data storage area may store data (such as audio data and a phone book) that is created based on use of the mobile phone 100, and the like. In addition, the memory 140 may include a high-speed random access memory, and may further include a nonvolatile memory such as at least one magnetic disk storage device, a flash storage device, or another volatile solid-state storage device. The memory 140 may further store a knowledge library, a tag library, and an algorithm library.

The input unit 150 may be configured to: receive entered digital or character information and generate key signal input related to a user setting and function control of the mobile phone 100. Specifically, the input unit 150 may include a touch panel 151 and another input device 152. The touch panel 151, also referred to as a touchscreen, may collect a touch operation of a user on or near the touch panel 151 (such as an operation of the user on or near the touch panel 151 by using any suitable object or accessory such as a finger or a stylus), and drive a corresponding connection apparatus based on a preset program. Optionally, the touch panel 151 may include two parts: a touch detection apparatus and a touch controller. The touch detection apparatus detects a touch location of the user, detects a signal brought by a touch operation, and delivers the signal to the touch controller. The touch controller receives touch information from the touch detection apparatus, converts the touch information into touch point coordinates, and then sends the touch point coordinates to the processor 130, and can receive and execute a command sent by the processor 130. In addition, the touch panel 151 may be of a resistive type, a capacitive type, an infrared type, a surface acoustic wave type, or the like. In addition to the touch panel 151, the input unit 150 may include the another input device 152. Specifically, the another input device 152 may include but is not limited to one or more of a physical keyboard, a function button (such as a sound volume control button or a power button), a trackball, a mouse, a joystick, and the like.

The display unit 160 may be configured to display information entered by the user or information provided for the user and various menus of the mobile phone 100. The display unit 160 may include a display panel 161. Optionally, the display panel 161 may be configured by using a liquid crystal display (liquid crystal display, LCD), an organic light-emitting diode (organic light-emitting diode, OLED), or the like. Further, the touch panel 151 may cover the display panel 161. After detecting a touch operation on or near the touch panel 151, the touch panel 151 transfers the touch operation to the processor 130 to determine a type of a touch event. Subsequently, the processor 130 provides corresponding visual output on the display panel 161 based on the type of the touch event. Although in FIG. 1, the touch panel 151 and the display panel 161 serve as two independent components to implement input and input functions of the mobile phone 100, in some embodiments, the touch panel 151 and the display panel 161 may be integrated to implement the input and output functions of the mobile phone 100.

The mobile phone 100 may further include at least one sensor 170, for example, an optical sensor, a motion sensor, and another sensor. Specifically, the optical sensor may include an ambient light sensor and a proximity sensor. The ambient light sensor may adjust luminance of the display panel 161 based on brightness of ambient light. The proximity sensor may turn off the display panel 161 and/or backlight when the mobile phone 100 moves to an ear. As a motion sensor, an accelerometer sensor may detect acceleration values in all directions (usually on three axes), may detect a value and a direction of gravity when the accelerometer sensor is stationary, and may be applied to an application to recognize a mobile phone posture (for example, screen switching between landscape and portrait modes, a related game, and magnetometer posture calibration), a function related to vibration recognition (such as a pedometer and a knock), and the like. For other sensors, such as a gyroscope, a barometer, a hygrometer, a thermometer, and an infrared sensor, that may be further configured for the mobile phone 100, details are not described herein.

The audio circuit 180, a speaker 181, and a microphone 182 may provide an audio interface between the user and the mobile phone 100. The audio circuit 180 may convert received audio data into an electrical signal and transmit the electrical signal to the speaker 181, and the speaker 181 converts the electrical signal into a sound signal for output. In addition, the microphone 182 converts a collected sound signal into an electrical signal, and the audio circuit 180 receives the electrical signal, converts the electrical signal into audio data, and then outputs the audio data to the RF circuit 110, to send the audio data to, for example, another mobile phone, or outputs the audio data to the memory 140 for further processing.

Wi-Fi is a short-distance wireless transmission technology. By using the Wi-Fi module 190, the mobile phone 100 may help the user send and receive an e-mail, browse a web page, access streaming media, and the like. Wi-Fi provides wireless broadband Internet access for the user. Although FIG. 1 shows the Wi-Fi module 190, it may be understood that, the Wi-Fi module 1670 is not a necessary component of the mobile phone 100, and may certainly be omitted as required without changing the essence of the present invention.

The processor 130 is a control center of the mobile phone 100, connects all parts of the entire mobile phone through various interfaces and lines, and performs various functions and data processing of the mobile phone 100 by running or executing the software program and/or the module stored in the memory 140 and by calling data stored in the memory 140, to implement a plurality of types of mobile phone based business. Optionally, the processor 130 may include one or more processing units. Preferably, an application processor and a modem processor may be integrated into the processor 130. The application processor mainly processes an operating system, a user interface, an application program, and the like. The modem processor mainly processes wireless communication. It may be understood that, alternatively, the modem processor may not be integrated into the processor 130.

In this embodiment of the present invention, the processor 130 may execute a program instruction stored in the memory 140, to implement the method shown in the following embodiment.

The mobile phone 100 further includes the power supply 120 (for example, a battery) that supplies power to each component. Preferably, the power supply may be logically connected to the processor 130 by using a power management system, to implement functions such as charging management, discharging management, and power consumption management by using the power management system.

Although not shown, the mobile phone 100 may further include a camera, a Bluetooth module, and the like. Details are not described herein.

The terminal provided in this embodiment of the present invention includes a profile platform end side, and the profile platform end side may abstract an information panorama of a user by collecting and analyzing various types of behavioral data of the user who uses the terminal. Based on a request of an application, the profile platform end side may predict a current possible behavior or preference of the user by using the abstracted information panorama, and return a predicted result to the application, that is, return a user profile (User Profile) to the application.

The user profile usually includes one or more user tags that are used to reflect a user characteristic. Optionally, a corresponding characteristic value may be further set for each user tag. In an example of a user A, as shown in Table 1, a user profile of the user A includes four user tags: “Gender”, “Address”, “Staying up late”, and “Workaholic”. In addition, a corresponding characteristic value is set for each user tag, and the characteristic value may be a specific attribute or score of the corresponding user tag.

For example, a characteristic value of the user tag “Gender” is female, that is, it indicates that a gender of the user A is female; a characteristic value of the user tag “Address” is Beijing, that is, it indicates that the user A lives in Beijing; and a characteristic value of the user tag “Staying up late” is “85 points” (for example, a full score is 100 points), that is, it indicates that a probability that the user A stays up late is relatively high. When a user B also has the user tag “Staying up late”, if a score of the user tag “Staying up late” for the user B is “60 points”, it indicates that a probability that the user B stays up late is less than the probability that the user A stays up late.

TABLE 1
User profile of the user A

| | |
|---|---|
| User tag | Characteristic value |
| Gender | Female |
| Address | Beijing |
| Staying up late | 85 points |

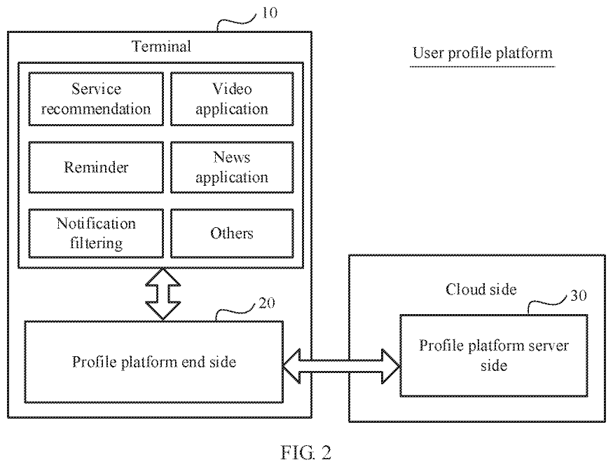

FIG. 2 is a schematic architecture diagram of a user profile platform according to an embodiment of the present invention. As shown in FIG. 2, the user profile platform includes at least one terminal 10 and a profile platform server side 30, and the terminal 10 includes a profile platform end side 20.

The profile platform end side 20 may provide user profiles for a plurality of applications in the terminal 10. The application may be a system-level application or a common-level application. The system-level application generally means that the application has system-level permission, and may obtain various system resources. The common-level application generally means that the application has common permission, and may not be able to obtain some system resources, or needs user authorization to obtain some system resources.

The system-level application may be an application pre-installed in the terminal 10. The common-level application may be an application pre-installed in the terminal 10, or may be an application subsequently installed by a user. For example, the profile platform end side 20 may separately provide user profiles for system-level applications such as a service recommendation application, a reminder application, and a notification filtering application. The service recommendation application, the reminder application, and the notification filtering application are respectively used to implement the service recommendation business, the reminder business, and the notification filtering business in the foregoing embodiment. Certainly, the profile platform end side 20 may further provide a user profile for a video application, a news application, or another application.

The profile platform end side 20 may further communicate with the profile platform server side 30 on a cloud side (namely, a network side).

In this embodiment of this application, to avoid a relatively large security risk and relatively heavy traffic overheads caused when the terminal 10 sends a large amount of collected behavioral data including user privacy to the profile platform server side 30, the profile platform end side 20 of the terminal 10 may generate one or more user tags and characteristic values of the user tags for the user based on behavioral data collected in a short period (for example, in a latest day), to obtain a short-term user profile corresponding to the user in the latest day.

Further, the terminal 10 may send the foregoing short-term user profile with a relatively small data amount and relatively low privacy that is generated daily to the profile platform server side 30. In this way, the profile platform server side 30 may receive short-term user profiles (for example, a short-term user profile 1 to a short-term user profile 10) generated by the terminal 10 daily in recent days, and the profile platform server side 30 may generate a long-term user profile with relatively high accuracy and stability based on the short-term user profile 1 to the short-term user profile 10 (namely, short-term user profiles in latest 10 days) through large data statistics, data mining, or the like.

Then, the profile platform server side 30 may send the long-term user profile to the terminal 10, and the profile platform end side 20 provides the long-term user profile with relatively high accuracy and stability for the service recommendation application, the reminder application, or the notification filtering application. In this way, traffic consumption and a risk of privacy leakage can be reduced while accuracy of a user profile used by the terminal 10 is improved.

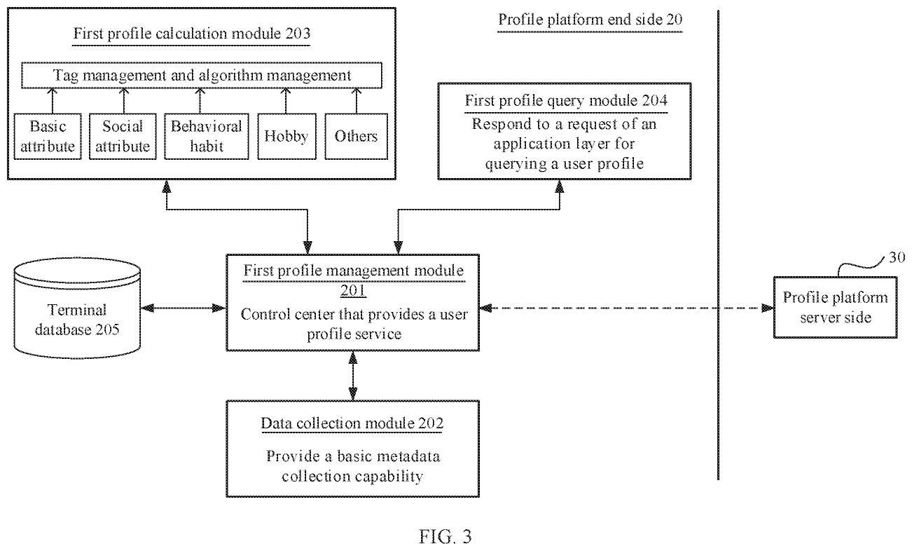

FIG. 3 is a schematic architecture diagram of the profile platform end side 20 according to an embodiment of the present invention. As shown in FIG. 3, the profile platform end side 20 may include a first profile management module 201, a data collection module 202, a first profile calculation module 203, a first profile query module 204, and a terminal database 205.

Data Collection Module 202

The data collection module 202 provides a basic metadata collection capability for the profile platform end side 20. The data collection module 202 may collect behavioral data generated when the user uses the terminal 10, and store, read, and write the collected behavioral data.

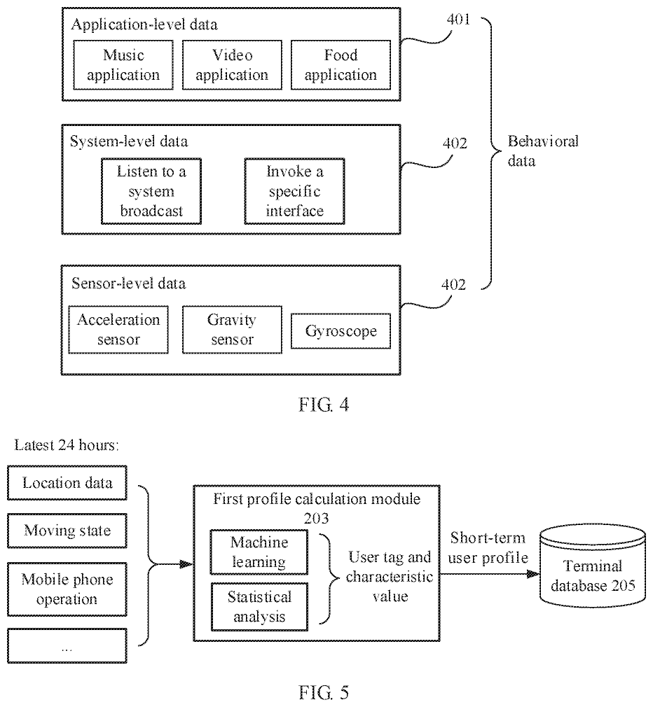

Specifically, FIG. 4 is a schematic diagram of behavioral data according to an embodiment of the present invention. As shown in FIG. 4, the behavioral data collected by the data collection module 202 may specifically include application-level data 401, system-level data 402, and sensor-level data 403.

The application-level data 401 may include data that is collected when an application at an application layer runs and that may reflect a user behavioral characteristic, for example, an application name, an application use time, and use duration. For example, when the running application is a video application, the data collection module 202 may further collect a name of a video being played, a video stop time, a quantity of video play episodes, and a total quantity of video episodes. When the running application is a music application, the data collection module 202 may further collect a name of music being played, a type of the music, play duration, and play frequency. When the running application is a food application, the data collection module 202 may further collect a current store name, a food type, and a store address. When collecting the behavioral data of the user, the data collection module 202 may further collect data by using a picture text awareness technology based on a specific case, for example, recognize text content in a picture by using an optical character recognition (optical character recognition, OCR) technology, to obtain text information in the picture.

The system-level data 402 may include data that is collected when various services provided at a framework layer (framework) run and that may reflect a user behavioral characteristic. For example, the data collection module 202 may listen to a broadcast message from an operating system or an application through a listening service, to obtain information such as a Bluetooth enable/disable state, a SIM card status, an application running status, an auto-rotate enable/disable state, and a hotspot enable/disable state. For another example, the data collection module 202 may invoke a specific interface such as a contact provider interface (contact provider API), a content provider interface (content provider API), and a calendar provider interface (calendar provider API) that are provided by an Android system, to obtain real-time scenario information of the system, for example, information such as audio, a video, a picture, a contact list, a schedule, a time, a date, a battery level, a network status, and a headset status.

The sensor-level data 403 may include data that is collected by using a component such as a sensor and that is used to reflect a user behavioral characteristic, for example, data generated when a sensor such as a distance sensor, an acceleration sensor, a pressure sensor, a gravity sensor, or a gyroscope runs. The data may be used to recognize that the user is in the following behavioral statuses: a driving state, a riding state, a walking state, a running state, a static state, and other states.

In this embodiment of this application, a collection period of the data collection module 202 may be set to a collection period with relatively short duration. For example, the collection period may be any value that does not exceed 24 hours. For example, the data collection module 202 may collect GPS data of the terminal 10 at intervals of five minutes, and collect, at intervals of 24 hours, a quantity of images stored in a graphics library of the terminal 10. In this case, the terminal 10 needs to maintain only behavioral data of the user collected in latest 24 hours, to avoid occupying excessive calculation resources and storage resources of the terminal 10.

For example, the data collection module 202 may collect the application-level data 401, the system-level data 402, and the sensor-level data 403 through system listening or by reading a specific data interface, calling a system service, performing tracing point collection, or the like.

First Profile Calculation Module 203

The first profile calculation module 203 may include a series of user tag generation algorithms or models. The first profile calculation module 203 is configured to: receive behavioral data of the user collected by the data collection module 202 in a short period (for example, in latest 24 hours), and determine a user tag and a characteristic value of the user in the short period based on the foregoing algorithm or model, to generate a short-term user profile of the user.

Specifically, as shown in FIG. 5, the first profile management module 201 may send behavioral data collected by the data collection module 202 in first duration (for example, in latest 24 hours) to the first profile calculation module 203, and the first profile calculation module 203 determines the user tag and the characteristic value of the user in the short period based on the foregoing algorithm or model through statistical analysis, machine learning, or the like, to generate the short-term user profile of the user.

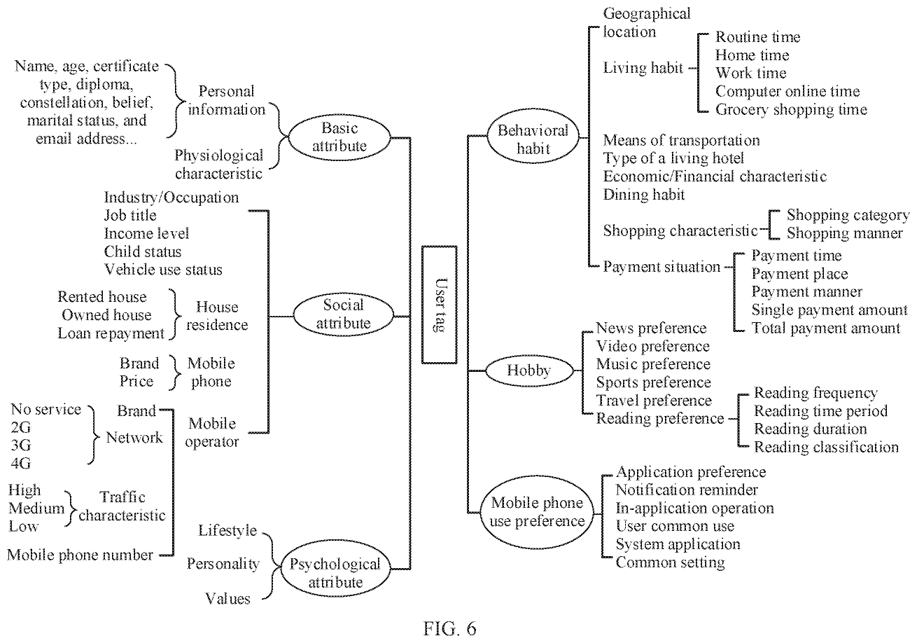

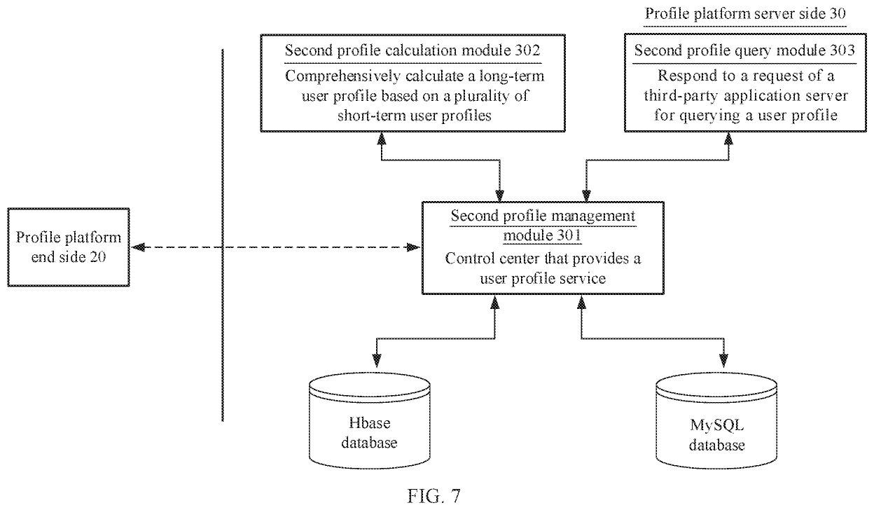

For example, as shown in FIG. 6, user tags included in the first profile calculation module 203 include but are not limited to the following six types of tags: a basic attribute, a social attribute, a behavioral habit, a hobby, a psychological attribute, and a mobile phone use preference.

The basic attribute includes but is not limited to personal information and a physiological characteristic. The personal information includes but is not limited to a name, an age, a certificate type, a diploma, a constellation, a belief, a marital status, and an email address.

The social attribute includes but is not limited to an industry/occupation, a job title, an income level, a child status, a vehicle use status, a house residence, a mobile phone, and a mobile operator. The house residence may include a rented house, an owned house, and a loan repayment. The mobile phone may include a brand and a price. The mobile operator may include a brand, a network, a traffic characteristic, and a mobile phone number. The brand may include Mobile, Unicom, Telecom, and others. The network may include No service, 2G, 3G, and 4G. The traffic characteristic may include high, middle, and low.

The behavioral habit includes but is not limited to a geographical location, a living habit, a means of transportation, a type of a living hotel, an economic/financial characteristic, a dining habit, a shopping characteristic, and a payment situation. The living habit may include a routine time, a home time, a work time, a computer online time, and a grocery shopping time. The shopping characteristic may include a shopping category and a shopping manner. The payment situation may include a payment time, a payment place, a payment manner, a single payment amount, and a total payment amount.

The hobby includes but is not limited to a reading preference, a news preference, a video preference, a music preference, a sports preference, and a travel preference. The reading preference may include reading frequency, a reading time period, total reading duration, and a reading classification.

The psychological attribute includes but is not limited to a lifestyle, a personality, and values.

The mobile phone use preference includes but is not limited to an application preference, a notification reminder, an in-application operation, user common use, a system application, and a common setting.

After the first profile management module 201 determines the user tag and the characteristic value of the user in the short period through statistical analysis, machine learning, or the like, an awareness result of a current real-time scenario may be obtained based on a current dynamic scenario in which the user is located, for example, a current time, a current location (longitude and latitude), a moving state, weather, a site (POI), a mobile phone status, and an enable/disable state. For example, the awareness result is on a working road and during traveling. Therefore, based on the awareness result of the current real-time scenario, the terminal may predict a subsequent behavior of the user on the terminal, to provide an intelligent customized personality service, for example, automatically display a home route and a road condition for the user in off-duty hours of the user.

It should be noted that the foregoing user tags are merely used as an example. In a specific implementation, a specific user tag under maintenance in the first profile calculation module 203 may be expanded based on a business requirement, and a new type of tag may be added, or existing tags may be further classified.

In this embodiment of this application, because the behavioral data collected and maintained by the data collection module 202 is behavioral data in latest first duration (for example, latest 24 hours), a period in which the first profile calculation module 203 generates a short-term user profile of the user may also be set to 24 hours. In other words, at intervals of 24 hours, the first profile calculation module 203 may generate a short-term user profile for the user based on the behavioral data collected by the data collection module 202 in the latest 24 hours. The short-term user profile may reflect a behavioral characteristic of the user in the latest 24 hours.

When the short-term user profile is being generated, the first profile calculation module 203 needs to process only the behavioral data in the first duration with a relatively short time span. Therefore, implementation complexity of the first profile calculation module 203 is greatly reduced, and a lot of calculation resources and storage resources of the terminal 10 are not consumed when the short-term user profile is being generated.

Each time the first profile calculation module 203 generates a short-term user profile of the user, the short-term user profile may be stored into the terminal database 205 (for example, SQLite) of the terminal 10 for cache for a specific time (for example, seven days), and the first profile management module 201 may send the short-term user profile to the profile platform server side 30.

In addition, the terminal 10 may encrypt the short-term user profile by using a preset encryption algorithm such as an advanced encryption standard (advanced encryption standard, AES), and store the encrypted short-term user profile in SQLite, to improve security of the short-term user profile in the terminal 10.

First Profile Management Module 201

The first profile management module 201 is coupled to all of the data collection module 202, the first profile calculation module 203, and the first profile query module 204.

Specifically, the first profile management module 201 is a control center that provides a user profile service in the terminal 10, and may be configured to provide various management functions and running scripts of the user profile service, for example, start a service of creating a user profile, obtain behavioral data of the user from the data collection module 202, instruct the first profile calculation module 203 to calculate a user profile, instruct the first profile query module 204 to authenticate an identity of the user or provide a user profile for an APP, update an algorithm library, clear outdated data, and synchronize data with the profile platform server side 30.

For example, after obtaining the short-term user profile generated by the first profile calculation module 203, the first profile management module 201 may synchronize the short-term user profile to the profile platform server side 30. For example, the terminal 10 may send the generated short-term user profile to the profile platform server side 30 based on a post request method in a network protocol (hypertext transfer protocol over secure socket layer, HTTPS).

Then, the first profile management module 201 may further store the long-term user profile generated by the profile platform server side 30 for the user into the database 205 of the terminal 10 for maintenance.

It may be learned that, in comparison with a manner in which the terminal 10 directly sends the collected behavioral data of the user to the profile platform server side 30, in this embodiment of this application, the terminal 10 sends the short-term user profile of the user to the profile platform server side 30. The short-term user profile is a user characteristic obtained after the collected behavioral data is abstracted, so that a data amount and data sensitivity of the short-term user profile are greatly reduced. Therefore, when the terminal 10 synchronizes the short-term user profile to the profile platform server side 30, traffic overheads and a risk of user privacy leakage can be greatly reduced.

Further, before synchronizing the short-term user profile to the profile platform server side 30, the terminal may further perform anonymization processing on a user tag in the short-term user profile, thereby further reducing a risk of user privacy leakage.

First Profile Query Module 204

The first profile query module 204 is configured to respond to a request of any application at an application layer for querying a user profile. For example, the first profile query module 204 may provide a provider interface meeting an Android unified standard, and the application may request, by invoking the provider interface, the first profile management module 201 to provide a user profile for the application.

In addition, when providing a user profile for the application, the first profile query module 204 may further authenticate, by using a digital signature or the like, an identity of a user that requests to provide a user profile, to reduce a risk of user privacy leakage.

FIG. 7 is a schematic architecture diagram of a profile platform server side according to an embodiment of the present invention. As shown in FIG. 7, the profile platform server side 30 may include a second profile management module 301, a second profile calculation module 302, and a second profile query module 303.

Second Profile Management Module 301

Similar to the first profile management module 201 in the foregoing terminal 10, the second profile management module 301 is a control center that provides a user profile service in the profile platform server side 30, and the second profile management module 301 is coupled to both the second profile calculation module 302 and the second profile query module 303.

Specifically, the second profile management module 301 may be configured to receive a short-term user profile sent by the terminal 10, and store short-term user profiles of different users into a distributed database such as HBase. The second profile management module 301 is further configured to instruct the second profile calculation module 302 to calculate, based on a plurality of short-term user profiles of a specified user that are sent by the terminal 10, a long-term user profile of the user in second duration with a relatively long time span. Certainly, the second profile management module 301 may further send the generated long-term user profile to the terminal 10, or store the long-term user profile into a MySQL database of the profile platform server side 30 for maintenance.

Second Profile Calculation Module 302

Similar to the first profile calculation module 203 of the terminal 10, the second profile calculation module 302 may include a series of user tag generation algorithms or models.

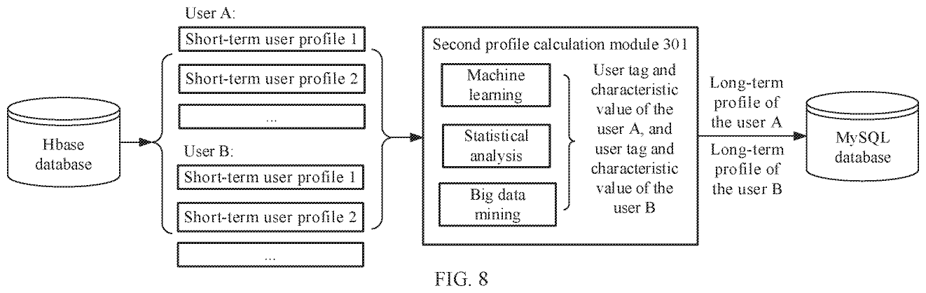

As shown in FIG. 8, the second profile management module 301 may input short-term user profiles generated by the terminal 10 daily for a user A in latest M days to the second profile calculation module 302. The second profile calculation module 302 determines user tags and characteristic values of the user A in the M days based on the foregoing algorithm or model through statistical analysis, machine learning, big data mining, and the like, to generate a long-term user profile of the user A in the M days, and send the long-term user profile to the terminal 10.

In other words, the second profile calculation module 302 may determine the long-term user profile with relatively high accuracy and stability for the user based on a plurality of short-term user profiles uploaded by the terminal 10. In this way, after receiving the long-term user profile sent by the profile platform server side 30, the terminal 10 may provide the long-term user profile for an application that requests to query a user profile, thereby improving accuracy and intelligence when the terminal 10 provides a smart service.

Certainly, the second profile management module 301 may also store, into the MySQL database of the profile platform server side 30, the long-term user profile determined by the second profile calculation module 302 for the user. Because the MySQL database is easy to read and modify, when the second profile calculation module 302 subsequently updates the long-term user profile of the user, the long-term user profile of the user may be updated in the MySQL database in a timely manner.

Second Profile Query Module 303

Similar to the first profile query module 204 of the terminal 10, the second profile query module 303 of the profile platform server side 30 may also provide a long-term user profile of the user for one or more third-party application servers.

For example, an API of representational state transfer (representative state transfer, REST) may be disposed in the second profile query module 303, and various third-party application servers may request, by invoking the API, the second profile management module 301 to provide the long-term user profile of the user for the servers.

For example, a server of an application 1 may send a first query request to the second profile query module 303 of the profile platform server side 30. The first query request is used to request to query a long-term user profile of a user A. In response to the first query request, the second profile query module 303 may request the second profile management module 301 to provide the long-term user profile of the user A for the server of the application 1 from the MySQL database, so that the server of the application 1 provides a customized service for the user A based on the long-term user profile of the user A when the user A uses the application 1.

For another example, the server of the application 1 may further send a second query request to the second profile query module 303 of the profile platform server side 30. The second query request is used to request to query a user list that has a specified user tag or a user list whose characteristic value of a user tag has a specified characteristic. For example, it is requested to query a user list whose characteristic value of a user tag “Online shopping” is “80 points” or above. In this case, in response to the second query request, the second profile query module 303 may request the second profile management module 301 to provide, for the server of the application 1, identifiers of one or more users meeting the characteristic value “80 points” or above of the user tag “Online shopping” in the MySQL database.

In addition, when providing a long-term user profile for a business cloud, the second profile query module 303 may further authenticate, by using an AK (access key ID)/SK (secret access key) or the like, an identity of a user that requests the long-term user profile, to reduce a risk of user privacy leakage.

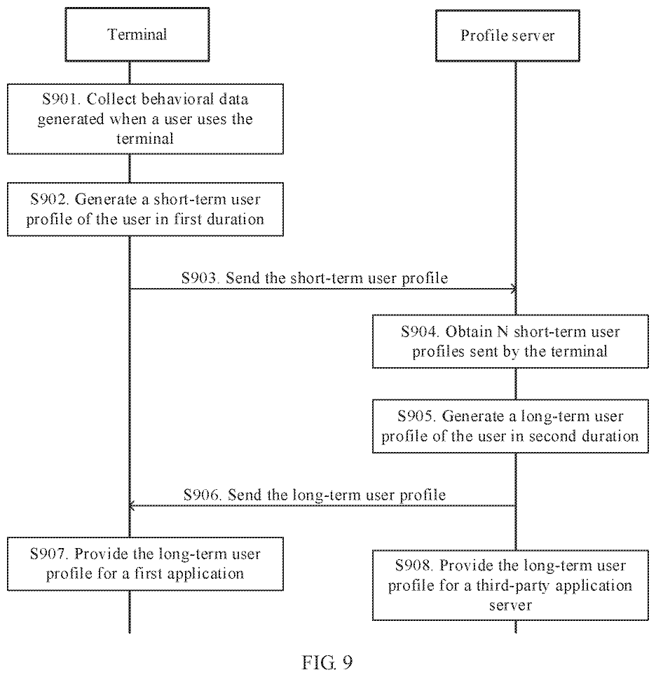

FIG. 9 is a schematic interaction diagram of a user profile generation method according to an embodiment of the present invention. The method is applied to a profile system that includes a terminal and a profile server. The terminal in the following steps S901 to S908 may be specifically the profile platform end side 20 in the foregoing embodiment, and the profile server in the following steps S901 to S908 may be specifically the profile platform server side 30 in the foregoing embodiment. As shown in FIG. 9, the method includes the following steps.

S901. The terminal collects behavioral data generated when a user uses the terminal, where the behavioral data reflects a behavioral characteristic of the user in first duration.

Referring to related descriptions of the foregoing data collection module 202, the data collection module 202 of the terminal may collect, through system listening or by reading a specific data interface, calling a system service, performing tracing point collection, or the like, the behavioral data generated when the user uses the terminal. For example, the behavioral data may specifically include application-level data and system-level data.

Specifically, the terminal may set different collection periods for different types of behavioral data. For example, for an application or a function that involves a frequent user operation, the terminal may set a relatively short collection period to collect behavioral data of the user. For example, the terminal may collect location information of the terminal and a working status of Bluetooth at intervals of five minutes. For an application or a function that involves a less frequent user operation, the terminal may set a relatively long collection period to collect behavioral data of the user. For example, the terminal may collect, at intervals of 24 hours, names and a quantity of applications installed in the terminal.

It should be noted that a collection period for collecting the foregoing behavioral data needs to be less than or equal to the first duration. For example, the first duration is 24 hours. A collection period for collecting all types of behavioral data by the terminal should not exceed 24 hours. In this way, the behavioral data collected by the terminal in the first duration may reflect the behavioral characteristic of the user in the first duration (namely, 24 hours).

Certainly, a person skilled in the art may set a value of the first duration based on an actual application scenario or actual experience. This is not limited in this embodiment of this application.

For example, when a calculation capability and a storage capability of the terminal are limited, the first duration may be set to a smaller value such as 12 hours. In this case, the terminal needs to maintain only behavioral data collected in latest 12 hours, to avoid occupying excessive calculation resources and storage resources of the terminal.

Alternatively, the terminal may set the first duration to a value that is consistent with a living habit or a use habit of the user. For example, when detecting that a sleeping habit of the user changes regularly at intervals of one week, the terminal may set the first duration to a total of seven days from Monday to Sunday.

Further, the data collection module 202 may store the collected behavioral data into a database (for example, SQLite) of the terminal. For example, a correspondence between a collection time and behavioral data corresponding to the collection time is stored into the database of the terminal in a form of a list. In addition, when storing the behavioral data, the terminal may further perform encryption processing on the collected behavioral data by using an encryption algorithm (for example, AES 256).

S902. The terminal generates a short-term user profile of the user in the first duration based on the behavioral data.

In step S902, after the behavioral data of the user is collected, a first profile management module 201 of the terminal may obtain, from the database of the terminal, the behavioral data collected in the first duration, and send the behavioral data to a first profile calculation module 203 of the terminal to generate the short-term user profile of the user in the first duration.

For example, the first duration is still 24 hours. The first profile management module 201 may extract, from the database of the terminal based on a collection time of each piece of behavioral data, behavioral data collected in latest 24 hours, and send the behavioral data to the first profile calculation module 203.

Therefore, referring to related descriptions of the first profile calculation module 203 in the foregoing embodiment, the first profile calculation module 203 may determine, based on a prestored algorithm or model through statistical analysis, machine learning, or the like, user tags and characteristic values that reflect user behavioral characteristics in the latest 24 hours. The user tags and the characteristic values of the user tags may be used as short-term user profiles of the user in the latest 24 hours.

For example, the behavioral data sent by the first profile management module 201 to the first profile calculation module 203 is a quantity of photos collected in the latest 24 hours. When the quantity of photos is greater than a first preset value (for example, 15), the first profile calculation module 203 may determine “Photography enthusiast” as one of user tags of the user, and a corresponding characteristic value is 60 points (for example, a full score is 100) in this case. When the quantity of photos is greater than a second preset value (for example, 25, where the second preset value is greater than the first preset value), the first profile calculation module 203 may determine “Photography enthusiast” as one of user tags of the user, and a corresponding characteristic value is 80 points in this case.

A statistical analysis algorithm used by the terminal to generate a short-term user profile may include sorting, weighting, averaging, and the like. A machine learning algorithm used by the terminal to generate a short-term user profile may include a logistic regression algorithm, an Adaboost algorithm, a Naive Bayes algorithm, a neural network algorithm, and the like. This is not limited in this embodiment of this application.

In addition, the first profile management module 201 may further preset an initiation condition. For example, an initiation condition such as powering on is registered in a job schedule service of an Android system. Therefore, when the initiation condition is met (that is, the terminal is powered on), the first profile management module 201 may be triggered to extract the behavioral data collected in the latest 24 hours, and send the behavioral data to the first profile calculation module 203 to generate the short-term user profile of the user.

It should be noted that the terminal may cyclically perform step S902 periodically or aperiodically. For example, at intervals of 24 hours, the terminal may be triggered to generate short-term user profiles of the user based on the behavioral data collected in the latest 24 hours. Then, the terminal may send these short-term user profiles to a profile server to generate a long-term user profile of the user.

Certainly, each time the first profile calculation module 203 generates a short-term user profile of the user, the short-term user profile may be stored into the database of the terminal. For example, the database of the terminal may maintain short-term user profiles generated by the first profile calculation module 203 daily in latest seven days. After generating a short-term user profile of the user on an eighth day, the first profile calculation module 203 may delete a short-term user profile stored on a first day when storing the short-term user profile on the eighth day, to ensure that the database of the terminal stores seven short-term user profiles generated in the latest seven days.

S903. The terminal sends the short-term user profile to the profile server.

For example, each time the first profile calculation module 203 generates the short-term user profile of the user, the first profile management module 201 may synchronize the generated short-term user profile to the profile server.

Alternatively, the first profile management module 201 may preset a time for synchronizing the short-term user profile to the profile server, for example, 19:00 every day. When a system time arrives at 19:00 every day, the first profile management module 201 may synchronize a latest generated short-term user profile to the profile server.

Alternatively, the first profile management module 201 may further synchronize, at a time, the seven short-term user profiles generated in the latest seven days to the profile server, and the profile server may receive, at a time, the short-term user profiles generated daily in the latest seven days that are sent by the terminal.

Optionally, a short-term user profile generated by the terminal may be synchronized between the terminal and the profile server based on a post/get request method in the HTTPS protocol.

In this case, the terminal may abstract, by using the collected behavioral data of the user in the first duration with a relatively short time span, the short-term user profile that is used to reflect the behavioral characteristic of the user in the first duration. Then, the terminal may send a short-term user profile generated each time to the profile server, and the profile server generates a long-term user profile for the user in second duration with a relatively long time span. Because an amount of the behavioral data processed by the terminal in the first duration is relatively small, calculation resources and storage resources of the terminal are not excessively occupied. In addition, a degree of association between the abstracted short-term user profile and user privacy is relatively low, and an amount of data is relatively small. Therefore, traffic consumed when the terminal sends the generated short-term user profile to the profile server is relatively small, and a risk of privacy leakage is relatively small.

S904. The profile server obtains N short-term user profiles sent by the terminal, where N≥1.

S905. The profile server generates the long-term user profile of the user in the second duration based on the N short-term user profiles, where the second duration is a time span including N times the first duration.

In step S904, a second profile management module 301 of the profile server may receive the N short-term user profiles sent by the terminal. The N short-term user profiles may be sent by the terminal to the profile server at a time, or may be separately sent by the terminal to the profile server for a plurality of times.

For example, the terminal sends a short-term user profile generated in the latest 24 hours (one day) to the profile server every day. After receiving the short-term user profile sent by the terminal every day, the profile server may store the short-term user profile and a receiving time of the short-term user profile into a database (for example, Hbase) of the profile server.

In step S905, after receiving a short-term user profile (for example, a short-term user profile 1) sent by the terminal on a current day, the profile server may obtain, from the database of the profile server, a stored short-term user profile 2 to a short-term user profile 30 received in latest 29 days. Then, the second profile management module 301 may send the short-term user profile 1 to the short-term user profile 30 to a second profile calculation module 302 of the profile server, and the second profile calculation module 302 determines user tags and characteristic values in latest 30 days based on a preset algorithm or model, to generate a long-term user profile of the user in the latest 30 days (namely, the second duration).

For example, taking a user tag “Photography enthusiast” in the short-term user profile 1 to the short-term user profile 30 as an example, if the short-term user profile sent by the terminal every day includes the user tag “Photography enthusiast” and a characteristic value of the user tag “Photography enthusiast”, the second profile calculation module 302 may calculate an average of characteristic values of the user tag “Photography enthusiast” in the 30 days, and further use the average as the characteristic value of the user tag “Photography enthusiast” in the long-term user profile in the latest 30 days.

Certainly, in addition to the foregoing method for calculating the average, the second profile calculation module 302 may use another algorithm or model to generate the user tag and the characteristic value in the long-term user profile. For example, if five of the 30 short-term user profiles corresponding to the 30 days that are received by the profile server include a user tag “Sports enthusiast”, and none of the remaining 25 short-term user profiles includes the user tag “Sports enthusiast”, it indicates that the user does not have a characteristic of “Sports enthusiast”. Therefore, the second profile calculation module 302 generates a long-term user profile without the user tag “Sports enthusiast” for the user in the latest 30 days.

For example, the profile server may calculate the long-term user profile of the user in the second duration through sorting or by using a logistic regression algorithm, an Adaboost algorithm, a protocol mapping algorithm, a regression analysis algorithm, a Web data mining algorithm, a random forest (Random Forests) algorithm, a K-nearest neighbor (K-nearestneighbors) algorithm, or the like. This is not limited in this embodiment of this application.

In this way, the second profile calculation module 302 may determine the long-term user profile with higher accuracy and stability for the user by using user behavioral characteristics in the second duration that are reflected by the N short-term user profiles.

A time length of the second duration corresponds to a time length reflected by the N short-term user profiles. If each short-term user profile reflects a user behavioral characteristic in the first duration, the second duration is specifically a time span including N times the first duration.

Certainly, a person skilled in the art may set a specific value of the second duration based on actual experience or an actual application scenario. For example, for a user tag that is susceptible to a time factor such as a name of a hit series or a favorite song of a user, the second profile calculation module 302 may set relatively short duration (for example, 30 days) as the second duration. For a user tag that is not susceptible to a time factor such as a commuting time or a taste of diet, the second profile calculation module 302 may set relatively long duration (for example, 90 days) as the second duration. This is not limited in this embodiment of this application. It should be noted that the second duration needs to be longer than the first duration used when the terminal generates the short-term user profile.

Correspondingly, when the second duration is 30 days, the profile server may obtain short-term user profiles (namely, N=30) sent by the terminal daily in latest 30 days, and send the 30 short-term user profiles to the second profile calculation module 302 as input. When the second duration is 90 days, the profile server may obtain short-term user profiles (namely, N=90) sent by the terminal daily in latest 90 days, and send the 90 short-term user profiles to the second profile calculation module 302 as input.

Further, after the second profile calculation module 302 obtains a long-term user profile of the user in the latest 30 days, if the profile server continues to obtain a short-term user profile sent by the terminal on a thirty-first day, the profile server may re-determine a long-term user profile of the user in latest 30 days based on 30 short-term user profiles sent by the terminal on a second day to the thirty-first day.

Certainly, each time the second profile calculation module 302 generates a long-term user profile of the user, the long-term user profile may be further stored into a database (for example, a MySQL database) of the profile server for backup.

S906. The profile server sends the long-term user profile to the terminal.

S907. When the terminal receives a request of a first application for obtaining a user profile, the terminal provides at least a part of the long-term user profile for the first application.

In step S906, after generating the long-term user profile with higher accuracy and stability for the user, the profile server may synchronize the long-term user profile to the terminal, and the terminal stores the long-term user profile into the database of the terminal.

In addition, the long-term user profile generated in the profile server is also continuously updated. Therefore, each time the terminal receives a new long-term user profile sent by the profile server, the terminal may store the new long-term user profile instead of an old long-term user profile into the database of the terminal, to ensure real-time quality and validity of the long-term user profile in the terminal.

Then, in step S907, when an application (for example, the first application) running on the terminal needs to provide smart business for the user, the first application may request, by invoking an interface such as a provider interface in a first profile query module 204, the first profile management module 201 to provide one or more user tags and characteristic values in the long-term user profile for the first application. For example, an identifier of a user tag “Gender” in the long-term user profile may be preset to 001, and the request sent by the first application to the first profile query module 204 may carry the identifier 001. In this case, the first profile management module 201 may feed back the user tag “Gender” and a characteristic value of the user tag “Gender” in the long-term user profile stored in the database of the first profile management module 201 to the first application as a request result.

The long-term user profile is a user profile with relatively high accuracy that is generated by the profile server based on a plurality of short-term user profiles. Therefore, the first application may use the long-term user profile to provide more intelligent and convenient smart business for the user.

S908. When the profile server receives a request of a third-party application profile server for obtaining a user profile, the profile server provides the long-term user profile for the third-party application profile server.

The long-term user profile generated by the profile server for the user is not only stored on the terminal side, but also backed up on the profile server. Therefore, when a profile server of a third-party application on a network side needs to provide smart business for the user, the second profile management module 301 may be requested, by invoking an REST interface or the like in a second profile query module 303, to provide a user profile of a related user for the third-party application profile server.

In this case, the second profile management module 301 may feed back the long-term user profile stored in the database of the second profile management module 301 to the third-party application profile server as a request result, so that the third-party application profile server can use the long-term user profile to provide more intelligent and convenient smart business for the user.

It may be learned that, in a process of generating a user profile in this embodiment of this application, the terminal and the profile server may cooperatively generate the user profile. First, the terminal that has a relatively weak calculation capability and storage capability generates a short-term user profile for the user in a relatively short time based on collected behavioral data, and then delivers the short-term user profile to the profile server to comprehensively calculate a long-term user profile with relatively high stability and accuracy based on a plurality of short-term user profiles. In this way, not only calculation resources and storage resources of the terminal can be prevented from being excessively occupied, but also privacy leakage and traffic overheads caused by directly uploading behavioral data of the user can be avoided, thereby ensuring stability and accuracy of a finally generated user profile.

Steps S901 to S903 and step S907 related to the terminal may be implemented by a processor of the terminal shown in FIG. 1 by executing a program instruction stored in a memory of the terminal. Similarly, steps S904 to S906 and step S908 related to the profile server may be implemented by a processor of the profile server by executing a program instruction stored in a memory of the profile server.

It may be understood that, to implement the foregoing functions, the terminal and the like include corresponding hardware structures and/or software modules for performing the functions. A person of ordinary skill in the art should easily be aware that, in combination with the examples described in the embodiments disclosed in this specification, units, algorithms, and steps may be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of the embodiments of this application.

In the embodiments of this application, the terminal may be divided into function modules based on the foregoing method examples. For example, each function module may be obtained through division based on each corresponding function, or two or more functions may be integrated into one processing module. The integrated module may be implemented in a form of hardware, or may be implemented in a form of a software function module. It should be noted that, in the embodiments of this application, module division is an example, and is merely logical function division. In actual implementation, another division manner may be used.

If each function module is obtained through division for each function, FIG. 3 is a possible schematic structural diagram of the terminal in the foregoing embodiment. The terminal includes a first profile management module 201, a data collection module 202, a first profile calculation module 203, a first profile query module 204, and a terminal database 205. All related actions of these function modules may be cited in related descriptions in FIG. 3, and details are not described herein again.

If each function module is obtained through division for each function, FIG. 7 is a possible schematic structural diagram of the profile server in the foregoing embodiment. The profile server includes a second profile management module 301, a second profile calculation module 302, and a second profile query module 303. All related actions of these function modules may be cited in related descriptions in FIG. 7, and details are not described herein again.

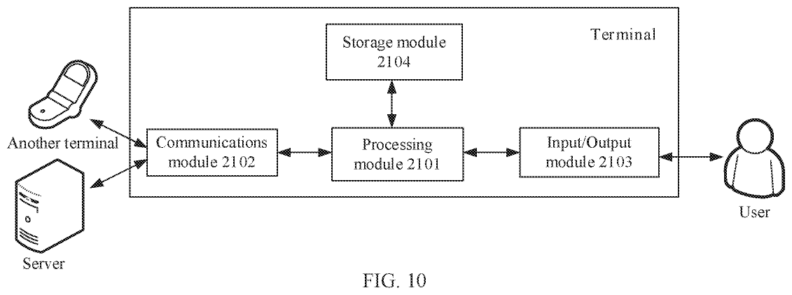

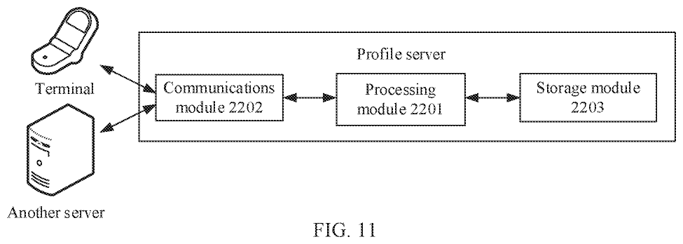

If an integrated unit is used. FIG. 10 is a possible schematic structural diagram of the terminal in the foregoing embodiment. The terminal includes a processing module 2101, a communications module 2102, an input/output module 2103, and a storage module 2104.

The processing module 2101 is configured to control and manage an action of the terminal. The communications module 2102 is configured to support communication between the terminal and another network entity. The input/output module 2103 is configured to receive information entered by a user or output information provided for the user and various menus of the terminal. The storage module 2104 is configured to store program code and data of the terminal.

If an integrated unit is used, FIG. 11 is a possible schematic structural diagram of the profile server in the foregoing embodiment. The profile server includes a processing module 2201, a communications module 2202, and a storage module 2203.

The processing module 2201 is configured to control and manage an action of the profile server. The communications module 2202 is configured to support communication between the profile server and another server or a terminal. The storage module 2203 is configured to store program code and data of the profile server.

Specifically, the processing module 2101/2201 may be a processor or a controller, for example, a central processing unit (Central Processing Unit, CPU), a GPU, a general purpose processor, a digital signal processor (Digital Signal Processor, DSP), an application-specific integrated circuit (Application-Specific Integrated Circuit, ASIC), a field programmable gate array (Field Programmable Gate Array, FPGA), or another programmable logic device, a transistor logic device, a hardware component, or any combination thereof. The processor may implement or execute various example logical blocks, modules, and circuits described with reference to content disclosed in this application. The processor may be a combination of processors implementing a computing function, for example, a combination of one or more microprocessors, or a combination of a DSP and a microprocessor.

The communications module 2102/2202 may be a transceiver, a transceiver circuit, a communications interface, or the like. For example, the communications module 1303 may be specifically a Bluetooth apparatus, a Wi-Fi apparatus, or a peripheral interface.

The input/output module 2103 may be a device, such as a touchscreen, a display, or a microphone, that receives information entered by a user or outputs information provided for the user. The display is used as an example. Specifically, the display may be configured by using a liquid crystal display, an organic light emitting diode, or the like. In addition, the display may be further integrated with a touchpad, and is configured to: collect a touch event on or near the display, and send collected touch information to another component (such as the processor).

The storage module 2104/2203 may be a memory. The memory may include a high-speed random access memory (RAM), and may further include a nonvolatile memory such as a magnetic disk storage device, a flash storage device, or another volatile solid-state storage device.

All or some of the foregoing embodiments may be implemented through software, hardware, firmware, or any combination thereof. When a software program is used to implement the embodiments, the embodiments may be implemented completely or partially in a form of a computer program product. The computer program product includes one or more computer instructions. When the computer program instructions are loaded and executed on the computer, the procedure or functions according to the embodiments of this application are all or partially generated. The computer may be a general-purpose computer, a dedicated computer, a computer network, or other programmable apparatuses. The computer instructions may be stored in a computer readable storage medium or may be transmitted from a computer readable storage medium to another computer readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid state disk Solid State Disk (SSD)), or the like.

The foregoing descriptions are merely specific implementations of this application, but are not intended to limit the protection scope of this application. Any variation or replacement within the technical scope disclosed in this application shall fall within the protection scope of this application. Therefore, the protection scope of this application shall be subject to the protection scope of the claims.

1. A user profile generation method, implemented by a terminal, wherein the user profile generation method comprises:
generating a short-term user profile of a user, wherein the short-term user profile reflects a first behavioral characteristic of the user in a first duration;
sending the short-term user profile to a profile server;
receiving a long-term user profile of the user from the profile server, wherein the long-term user profile is based on the short-term user profile, wherein the long-term user profile reflects a second behavioral characteristic of the user in a second duration, and wherein the second duration is longer than the first duration; and
providing a part of the long-term user profile for a first application.

2. The user profile generation method of claim 1, further comprising:
generating behavioral data when the terminal is in use;
collecting the behavioral data; and
generating the short-term user profile based on the behavioral data collected in the first duration, wherein the short-term user profile comprises a user tag and a characteristic value, and wherein the characteristic value corresponds to the user tag.

3. The user profile generation method of claim 2, wherein the behavioral data comprises data that is from an application at an application layer and that reflects a first user behavioral characteristic, data is from a service at a framework layer and that reflects a second user behavioral characteristic, and data from a sensor of the terminal that reflects a third user behavioral characteristic, wherein the user profile generation method further comprises collecting the behavioral data by at least listening to a broadcast message, reading a specific data interface, calling a system service, or performing tracing point collection.

4. The user profile generation method of claim 2, further comprising performing statistical analysis and machine learning on the behavioral data from the first duration to obtain the user tag and the characteristic value the user tag.

5. The user profile generation method of claim 1, further comprising storing the short-term user profile and the long-term user profile into a database of the terminal, wherein the database stores a short-term user profile in the first duration in response to the first duration being a latest duration.

6. A user profile generation method, implemented by a profile server, wherein the user profile generation method comprises:
obtaining a short-term user profile from a terminal, wherein the short-term user profile reflects a first behavioral characteristic of a user in a first duration;
generating a long-term user profile of the user based on the short-term user profile, wherein the long-term user profile reflects a second behavioral characteristic of the user in a second duration, and wherein the second duration is longer than the first duration; and
sending the long-term user profile to the terminal.

7. The user profile generation method of claim 6, wherein the short-term user profile comprises a first user tag and a first characteristic value, wherein the first characteristic value corresponds to the first user tag, wherein the long-term user profile comprises a second user tag and a second characteristic value, and wherein the second characteristic value corresponds to the second user tag.

8. The user profile generation method of claim 6, wherein after generating the long-term user profile of the user, the user profile generation method further comprises:
receiving a first query request from a third-party application profile server, wherein the first query request requests to query the long-term user profile of the user; and
sending the long-term user profile of the user to the third-party application profile server in response to the first query request.

9. The user profile generation method of claim 6, further comprising:
storing a correspondence between each of a plurality of users and the long-term user profile;
receiving a second query request from a third-party application profile server, wherein the second query request comprises a user type;
searching a plurality of long-term user profiles of the users for a target long-term user profile that meets the user type in response to the second query request; and
sending an identifier of a user corresponding to the target long-term user profile to the third-party application profile server.

10. The user profile generation method of claim 6, further comprising:
receiving a short-term user profile;
receiving the long-term user profile;
storing the short-term user profile into a first database of the profile server; and
storing the long-term user profile into a second database of the profile server.

11. A terminal, comprising:
a profile control center configured to:
send a short-term user profile of a user to a profile server, wherein the short-term user profile reflects a first behavioral characteristic of the user in a first duration;
receive a long-term user profile from the profile server for the user, wherein the long-term user profile is based on the short-term user profile, wherein the long-term user profile reflects a second behavioral characteristic of the user in a second duration, and wherein the second duration is longer than the first duration;
a data collector coupled to the profile control center and configured to collect behavioral data based on terminal use;
a profile calculator coupled to the profile control center and configured to generate the short-term user profile based on the behavioral data from the first duration, wherein the first duration is a latest duration, wherein the short-term user profile comprises a user tag and a characteristic value, wherein the characteristic value corresponds to the user tag;
a profile query system coupled to the profile control center and configured to provide a part of the long-term user profile for a first application; and
a database coupled to the profile control center configured to store the part of the long-term user profile.

12. (canceled)

13. The terminal of claim 11, wherein the behavioral data comprises data from an application and that reflects a first user behavioral characteristic, data from a service at a framework layer and that reflects a second user behavioral characteristic, and data from a sensor of the terminal and that reflects a third user behavioral characteristic, wherein the data collector is further configured to collect the behavioral data by at least one of; listening to a broadcast message, reading a specific data interface, calling a system service, or performing tracing point collection.

14. The terminal of claim 11, wherein the profile calculator is further configured to perform statistical analysis and machine learning on the behavioral data from the first duration to obtain the user tag and the characteristic value that corresponds to the user tag.

15. The terminal of claim 11, wherein the profile control center is further configured to store the short-term user profile and the long-term user profile into the database, wherein the database is configured to store the short-term user profile the first duration, wherein the first duration is a latest duration.

16.-25. (canceled)

26. The user profile generation method of claim 3, further comprising performing statistical analysis and machine learning on the behavioral data in the first duration to obtain the user tag and the characteristic value of user tag.

27. The user profile generation method of claim 2, further comprising storing the short-term user profile and the long-term user profile into a database of the terminal, wherein the database stores a short-term user profile in the first duration in response to the first duration being a latest duration.

28. The user profile generation method of claim 3, further comprising storing the short-term user profile and the long-term user profile into a database of the terminal, wherein the database stores a short-term user profile in the first duration in response to the first duration being a latest duration.

29. The user profile generation method of claim 7, wherein after generating the long-term user profile, the user profile generation method further comprises:
receiving a first query request from a third-party application profile server, wherein the first query request requests to query the long-term user profile of the user; and
sending the long-term user profile of the user to the third-party application profile server in response to the first query request.

30. The user profile generation method of claim 7, further comprising:
storing a correspondence between each of a plurality of users and the long-term user profile;
receiving a second query request from a third-party application profile server, wherein the second query request comprises a user type;
searching a plurality of long-term user profiles of the users for a target long-term user profile that meets the user type in response to the second query request; and
sending an identifier of at least one of the users corresponding to the target long-term user profile to the third-party application profile server.

31. The user profile generation method of claim 7, wherein the method further comprises:
receiving a short-term user profile;
receiving the long-term user profile;
storing the short-term user profile into a first database of the profile server; and
storing the long-term user profile into a second database of the profile server.
